(19) United States
(12) Patent Application Publication
(10) Pub. No.: US 2007/0013293 A1
(43) Pub. Date: Jan. 18, 2007

(54) OLED device having spacers

(75) Inventor: Ronald S. Cok, Rochester, NY (US)

Correspondence Address: Paul A. Leipold;Patent Legal Staff, Eastman Kodak Company, 343 State Street, Rochester, NY, 14650-2201, US

(73) Assignee: Eastman Kodak Company

(21) Appl. No.: 11/179,186

(22) Filed: Jul. 12, 2005

(51) Int. Cl. H05B 33/00

(52) U.S. Cl. 313/504; 313/506

(57) ABSTRACT

An organic light-emitting diode (OLED) device, comprising: a substrate; an OLED formed on the substrate comprising a first electrode formed over the substrate, one or more layers of organic material, one of which emits light, formed over the first electrode, and a transparent second electrode formed over the one or more layers of organic material, the transparent second electrode and layer(s) of organic light-emitting material having a first refractive index range; a transparent cover provided over the OLED through which light from the OLED is emitted, the cover having a second refractive index; a light scattering layer located between the substrate and cover for scattering light emitted by the light-emitting layer; and an auxiliary electrode grid located above the transparent second electrode, providing spacing between the transparent second electrode and the cover, and forming transparent gaps between the transparent second electrode and the cover within grid openings, the transparent gaps having a third refractive index lower than each of the first refractive index range and second refractive index.

### FIELD OF THE INVENTION

The present invention relates to organic light-emitting diode (OLED) devices, and more particularly, to OLED device structures for improving light output, improving robustness, and reducing manufacturing costs.

### BACKGROUND OF THE INVENTION

Organic light-emitting diodes (OLEDs) are a promising technology for flat-panel displays and area illumination lamps. The technology relies upon thin-film layers of materials coated upon a substrate and employing an encapsulating cover affixed to the substrate around the periphery of the OLED device. The thin-film layers of materials can include, for example, organic materials, electrodes, conductors, and silicon electronic components as are known and taught in the OLED art. The cover includes a cavity to avoid contacting the cover to the thin-film layers of materials when the cover is affixed to the substrate.

OLED devices generally can have two formats known as small molecule devices such as disclosed in U.S. Pat. No. 4,476,292 and polymer OLED devices such as disclosed in U.S. Pat. No. 5,247,190. Either type of OLED device may include, in sequence, an anode, an organic electroluminescent (EL) element, and a cathode. The organic EL element disposed between the anode and the cathode commonly includes an organic hole-transporting layer (HTL), an emissive layer (EML) and an organic electron-transporting layer (ETL). Holes and electrons recombine and emit light in the EML layer. Tang et al. (Appl. Phys. Lett., 51, 913 (1987), Journal of Applied Physics, 65, 3610 (1989), and U.S. Pat. No. 4,769,292) demonstrated highly efficient OLEDs using such a layer structure. Since then, numerous OLEDs with alternative layer structures, including polymeric materials, have been disclosed and device performance has been improved.

Light is generated in an OLED device when electrons and holes that are injected from the cathode and anode, respectively, flow through the electron transport layer and the hole transport layer and recombine in the emissive layer. Many factors determine the efficiency of this light generating process. For example, the selection of anode and cathode materials can determine how efficiently the electrons and holes are injected into the device; the selection of ETL and HTL can determine how efficiently the electrons and holes are transported in the device, and the selection of EML can determine how efficiently the electrons and holes be recombined and result in the emission of light, etc. It has been found, however, that one of the key factors that limits the efficiency of OLED devices is the inefficiency in extracting the photons generated by the electron-hole recombination out of the OLED devices. Due to the high optical indices of the organic materials used, most of the photons generated by the recombination process are actually trapped in the devices due to total internal reflection. These trapped photons never leave the OLED devices and make no contribution to the light output from these devices.

A typical OLED device uses a glass substrate, a transparent conducting anode such as indium-tin-oxide (ITO), a stack of organic layers, and a reflective cathode layer. Light generated from the device is emitted through the glass substrate. This is commonly referred to as a bottom-emitting device. Alternatively, a device can include a substrate, a reflective anode, a stack of organic layers, and a top transparent cathode layer. Light generated from the device is emitted through the top transparent electrode. This is commonly referred to as a top-emitting device. In these typical devices, the index of the ITO layer, the organic layers, and the glass is about 2.0, 1.7, and 1.5 respectively. It has been estimated that nearly 60% of the generated light is trapped by internal reflection in the ITO/organic EL element, 20% is trapped in the glass substrate, and only about 20% of the generated light is actually emitted from the device and performs useful functions.

OLED devices can employ a variety of light-emitting organic materials patterned over a substrate that emit light of a variety of different frequencies, for example red, green, and blue, to create a full-color display. Alternatively, it is known to employ an unpatterned broad-band emitter, for example white, together with patterned color filters, for example red, green, and blue, to create a full-color display. The color filters may be located on the substrate, for a bottom-emitter, or on the cover, for a top-emitter.

Referring to FIG. 2, an OLED device as taught in the prior art includes a transparent substrate 10 on which are formed thin-film electronic components 20, for example conductors, thin-film transistors, and capacitors in an active-matrix device or conductors in a passive-matrix device. Color filters 28R, 28G, and 28B are patterned on the substrate 10. Over the color filters 28R, 28G, and 28B are formed first transparent electrode(s) 14. One or more layers of unpatterned organic materials 16 are formed over the first electrode(s) 14, at least one layer of which emits broadband light. One or more reflective second electrode(s) 18 are formed over the layers of organic materials 16. An encapsulating cover 12 with a cavity forming a gap 32 to avoid contacting the thin-film layers 14, 16, 18, 20 is affixed to the substrate 10. In some designs, it is proposed to fill the gap 32 with a curable polymer or resin material to provide additional rigidity, or a desiccant to provide protection against moisture. The second electrode(s) 18 may be continuous over the surface of the OLED. Upon the application of a voltage across the first and second electrodes 14 and 18 provided by the thin-film electronic components 20, a current can flow through the organic material layers 16 to cause one of the organic layers to emit light 50a through the substrate. The arrangement used in FIG. 2 typically has a thick, highly conductive, reflective electrode 18 and suffers from a reduced aperture ratio. Referring to FIG. 3, a top-emitter configuration employing patterned emissive materials 26R, 26G, 26B for emitting different colors of light can locate a first electrode 14 partially over the thin-film electronic components 20 thereby increasing the amount of light-emitting area 26. Since, in this top-emitter case, the first electrode 14 does not transmit light, it can be thick, opaque, and highly conductive. However, the second electrode 18 must then be at least partially transparent.

Materials for forming the transparent electrode of top emitting displays are well known in the art and include transparent conductive oxides (TCO's), such as indium tin oxide (ITO); thin layers of metal, such as Al, having a thickness on the order of 20 nm; and conductive polymers such as polythiophene. However, many electrode materials that are transparent, such as ITO, have low conductivity, which results in a voltage drop across the display. This in turn causes variable light output from the light emitting elements in the display, resistive heating, and power loss. Resistance can be lowered by increasing the thickness of the top electrode, but this decreases the electrode's transparency.

One proposed solution to this problem is to use an auxiliary electrode 24 above or below the transparent electrode layer and located between the pixels, as taught by US2002/0011783, published Jan. 31, 2002, by Hosokawa. The auxiliary electrode 24 is not required to be transparent and therefore can be of a higher conductivity than the transparent electrode. The auxiliary electrode is typically constructed of conductive metals (e.g., Al, Ag, Cu, Au).

U.S. Pat. No. 6,812,637 entitled “OLED Display with Auxiliary Electrode” by Cok et al issued Nov. 2, 2004 describes a light-absorbing auxiliary electrode in electrical contact with a transparent electrode and located between the light-emitting elements of the display (as shown in FIG. 3 thereof). Such an auxiliary electrode is useful for improving the conductivity of the transparent electrode and the contrast of the display.

In commercial practice, the substrate and cover have comprised 0.7 mm thick glass, for example as employed in the Eastman Kodak Company LS633 digital camera. For relatively small devices, for example less than five inches in diagonal, the use of a cavity in an encapsulating cover 12 is an effective means of providing relatively rigid protection to the thin-film layers of materials 14, 16, 18, 20. However, for very large devices, the substrate 10 or cover 12, even when composed of rigid materials like glass and employing materials in the gap 32, can bend slightly and cause the inside of the encapsulating cover 12 or materials in the gap 32 to contact or press upon the thin-film layers of materials 14, 16, 18, 20, possibly damaging them and reducing the utility of the OLED device.

It is known to employ spacer elements to separate thin sheets of materials. For example, U.S. Pat. No. 6,259,204 B1 entitled “Organic electroluminescent device” describes the use of spacers to control the height of a sealing sheet above a substrate. Such an application does not, however, provide protection to thin-film layers of materials in an OLED device. US20040027327 A1 entitled “Components and methods for use in electro-optic displays” published 20040212 describes the use of spacer beads introduced between a backplane and a front plane laminate to prevent extrusion of a sealing material when laminating the backplane to the front plane of a flexible display. However, in this design, any thin-film layers of materials are not protected when the cover is stressed. Moreover, the sealing material will reduce the transparency of the device and requires additional manufacturing steps.

U.S. Pat. No. 6,821,828 B2 entitled “Method of manufacturing a semiconductor device” granted 20041123 describes an organic resin film such as an acrylic resin film patterned to form columnar spacers in desired positions in order to keep two substrates apart. The gap between the substrates is filled with liquid crystal materials. The columnar spacers may be replaced by spherical spacers sprayed onto the entire surface of the substrate. However, columnar spacers are formed lithographically and require complex processing steps and expensive materials. Moreover, this design is applied to liquid crystal devices and does not provide protection to thin-film structures deposited on a substrate.

U.S. Pat. No. 6,551,440 B2 entitled “Method of manufacturing color electroluminescent display apparatus and method of bonding light-transmitting substrates” granted 20030422 describes use of a spacer of a predetermined grain diameter interposed between substrates to maintain a predetermined distance between the substrates. When a sealing resin deposited between the substrates spreads, surface tension draws the substrates together. The substrates are prevented from being in absolute contact by interposing the spacer between the substrates, so that the resin can smoothly be spread between the substrates. This design does not provide protection to thin-film structures deposited on a substrate.

The use of cured resins is also optically problematic for top-emitting OLED devices. As is well known, a significant portion of the light emitted by an OLED may be trapped in the OLED layers, substrate, or cover. By filling the gap with a resin or polymer material, this problem may be exacerbated.

Referring to FIG. 10, a prior-art bottom-emitting OLED has a transparent substrate 10, a transparent first electrode 14, one or more layers 16 of organic material, one of which is light-emitting, a reflective second electrode 18, a gap 32 and an encapsulating cover 12. The encapsulating cover 12 may be opaque and may be coated directly over the second electrode 18 so that no gap 32 exists. When a gap 32 does exist, it may be filled with polymer or desiccants to add rigidity and reduce water vapor permeation into the device. Light emitted from one of the organic material layers 16 can be emitted directly out of the device, through the substrate 10, as illustrated with light ray 1. Light may also be emitted and internally guided in the substrate 10 and organic layers 16, as illustrated with light ray 2. Alternatively, light may be emitted and internally guided in the layers 16 of organic material, as illustrated with light ray 3. Light rays 4 emitted toward the reflective second electrode 18 are reflected by the reflective second electrode 18 toward the substrate 10 and then follow one of the light ray paths 1, 2, or 3.

A variety of techniques have been proposed to improve the out-coupling of light from thin-film light emitting devices. For example, diffraction gratings have been proposed to control the attributes of light emission from thin polymer films by inducing Bragg scattering of light that is guided laterally through the emissive layers; see “Modification of polymer light emission by lateral microstructure” by Safonov et al., Synthetic Metals 116, 2001, pp. 145-148, and “Bragg scattering from periodically microstructured light emitting diodes” by Lupton et al., Applied Physics Letters, Vol. 77, No. 21, Nov. 20, 2000, pp. 3340-3342. Brightness enhancement films having diffractive properties and surface and volume diffusers are described in WO0237568 A1 entitled “Brightness and Contrast Enhancement of Direct View Emissive Displays” by Chou et al., published May 10, 2002. The use of micro-cavity techniques is also known; for example, see “Sharply directed emission in organic electroluminescent diodes with an optical-microcavity structure” by Tsutsui et al., Applied Physics Letters 65, No. 15, Oct. 10, 1994, pp. 1868-1870. However, none of these approaches cause all, or nearly all, of the light produced to be emitted from the device. Moreover, such diffractive techniques cause a significant frequency dependence on the angle of emission so that the color of the light emitted from the device changes with the viewer's perspective.

Reflective structures surrounding a light-emitting area or pixel are referenced in U.S. Pat. No. 5,834,893 issued Nov. 10, 1998 to Bulovic et al. and describe the use of angled or slanted reflective walls at the edge of each pixel. Similarly, Forrest et al. describe pixels with slanted walls in U.S. Pat. No. 6,091,195 issued Jul. 18, 2000. These approaches use reflectors located at the edges of the light emitting areas. However, considerable light is still lost through absorption of the light as it travels laterally through the layers parallel to the substrate within a single pixel or light emitting area.

Scattering techniques are also known. Chou (International Publication Number WO 02/37580 A1) and Liu et al. (U.S. Patent Application Publication No. 2001/0026124 A1) taught the use of a volume or surface scattering layer to improve light extraction. The scattering layer is applied next to the organic layers or on the outside surface of the glass substrate and has optical index that matches these layers. Light emitted from the OLED device at higher than critical angle that would have otherwise been trapped can penetrate into the scattering layer and be scattered out of the device. The efficiency of the OLED device is thereby improved but still has deficiencies as explained below.

U.S. Pat. No. 6,787,796 entitled “Organic electroluminescent display device and method of manufacturing the same” by Do et al issued 20040907 describes an organic electroluminescent (EL) display device and a method of manufacturing the same. The organic EL device includes a substrate layer, a first electrode layer formed on the substrate layer, an organic layer formed on the first electrode layer, and a second electrode layer formed on the organic layer, wherein a light loss preventing layer having different refractive index areas is formed between layers of the organic EL device having a large difference in refractive index among the respective layers. U.S. Patent Application Publication No. 2004/0217702 entitled “Light extracting designs for organic light emitting diodes” by Garner et al., similarly discloses use of microstructures to provide internal refractive index variations or internal or surface physical variations that function to perturb the propagation of internal waveguide modes within an OLED. When employed in a top-emitter embodiment, the use of an index-matched polymer adjacent the encapsulating cover is disclosed.

However, scattering techniques, by themselves, cause light to pass through the light-absorbing material layers multiple times where they are absorbed and converted to heat. Moreover, trapped light may propagate a considerable distance horizontally through the cover, substrate, or organic layers before being scattered out of the device, thereby reducing the sharpness of the device in pixellated applications such as displays. For example, as illustrated in FIG. 11, a prior-art pixellated bottom-emitting OLED device may include a plurality of independently controlled pixels 60, 62, 64, 66, and 68 and a scattering element 21, typically formed in a layer, located between the transparent first electrode 12 and the substrate 10. A light ray 5 emitted from the light-emitting layer may be scattered multiple times by light scattering element 21, while traveling through the substrate 10, organic layer(s) 16, and transparent first electrode 14 before it is emitted from the device. When the light ray 5 is finally emitted from the device, the light ray 5 has traveled a considerable distance through the various device layers from the original pixel 60 location where it originated to a remote pixel 68 where it is emitted, thus reducing sharpness. Most of the lateral travel occurs in the substrate 10, because that is by far the thickest layer in the package. Also, the amount of light emitted is reduced due to absorption of light in the various layers. If the light scattering layer is alternatively placed adjacent to a transparent encapsulating cover of a top-emitting device as illustrated in FIG. 12, the light may similarly travel a significant distance in the encapsulating cover 12 before being emitted.

Light-scattering layers used externally to an OLED device are described in U.S. Patent Application Publication No. 2005/0018431 entitled “Organic electroluminescent devices having improved light extraction” by Shiang and U.S. Pat. No. 5,955,837 entitled “System with an active layer of a medium having light-scattering properties for flat-panel display devices” by Horikx, et al. These disclosures describe and define properties of scattering layers located on a substrate in detail. Likewise, U.S. Pat. No. 6,777,871 entitled “Organic ElectroLuminescent Devices with Enhanced Light Extraction” by Duggal et al., describes the use of an output coupler comprising a composite layer having specific refractive indices and scattering properties. While useful for extracting light, this approach will only extract light that propagates in the substrate (illustrated with light ray 2) and will not extract light that propagates through the organic layers and electrodes (illustrated with light ray 3). Moreover, if applied to display devices, this structure will decrease the perceived sharpness of the display. Referring to FIG. 13, the sharpness of an active-matrix OLED device employing a light-scattering layer coated on the substrate is illustrated. The average MTF (sharpness) of the device (in both horizontal and vertical directions) is plotted for an OLED device with the light-scattering layer and without the light scattering layer. As is shown, the device with the light-scattering layer is much less sharp than the device without the light scattering layer, although more light was extracted (not shown) from the OLED device with the light-scattering layer.

U.S. Patent Application Publication No. 2004/0061136 entitled “Organic light emitting device having enhanced light extraction efficiency” by Tyan et al., describes an enhanced light extraction OLED device that includes a light scattering layer. In certain embodiments, a low-index isolation layer (having an optical index substantially lower than that of the organic electroluminescent element) is employed adjacent to a reflective layer in combination with the light scattering layer to prevent low angle light from striking the reflective layer, and thereby minimize absorption losses due to multiple reflections from the reflective layer. The particular arrangements, however, may still result in reduced sharpness of the device.

There is a need therefore for an improved OLED device structure that that avoids the problems noted above and improves the robustness and performance of the device and reduces manufacturing costs.

### SUMMARY OF THE INVENTION

In accordance with one embodiment, the invention is directed towards an organic light-emitting diode (OLED) device, comprising: a substrate; an OLED formed on the substrate comprising a first electrode formed over the substrate, one or more layers of organic material, one of which emits light, formed over the first electrode, and a transparent second electrode formed over the one or more layers of organic material, the transparent second electrode and layer(s) of organic light-emitting material having a first refractive index range; a transparent cover provided over the OLED through which light from the OLED is emitted, the cover having a second refractive index; a light scattering layer located between the substrate and cover for scattering light emitted by the light-emitting layer; and an auxiliary electrode grid located above the transparent second electrode, providing spacing between the transparent second electrode and the cover, and forming transparent gaps between the transparent second electrode and the cover within grid openings, the transparent gaps having a third refractive index lower than each of the first refractive index range and second refractive index.

### ADVANTAGES

The present invention has the advantage that it improves the robustness and performance of an OLED device and reduces manufacturing costs.

### BRIEF DESCRIPTION OF THE DRAWINGS

FIG. 1 is a cross section of a top-emitter OLED device according to one embodiment of the present invention;

FIG. 2 is a cross section of a prior-art OLED device;

FIG. 3 is a cross section of an alternative prior-art OLED device;

FIG. 4 is a cross section of a top-emitter OLED device according to an alternative embodiment of the present invention;

FIG. 5 is a cross section of a top-emitter OLED device according to another alternative embodiment of the present invention;

FIG. 6 is a cross section of a top-emitter OLED device having an end cap according to yet another embodiment of the present invention;

FIG. 7 is a top view of an OLED device having an auxiliary grid distributed between light-emitting areas according to another embodiment of the present invention;

FIG. 8 is a cross section of a top-emitter OLED device according to yet another alternative embodiment of the present invention;

FIG. 9 is a partial detail cross section of a top-emitter OLED device spacer element according to an alternative embodiment of the present invention;

FIG. 10 is a cross section of a prior-art bottom-emitting OLED device illustrating light emission;

FIG. 11 is a cross section of a bottom-emitting OLED device having a scattering layer as described in the prior-art illustrating light emission;

FIG. 12 is a cross section of a top-emitting OLED device having a scattering layer as suggested by the prior-art illustrating light emission;

FIG. 13 is a graph illustrating the sharpness of a prior-art OLED display with and without a scattering layer; and

FIG. 14 is a cross section of a top-emitter OLED device according to yet another alternative embodiment of the present invention.

It will be understood that the figures are not to scale since the individual layers are too thin and the thickness differences of various layers too great to permit depiction to scale.

### DETAILED DESCRIPTION OF THE INVENTION

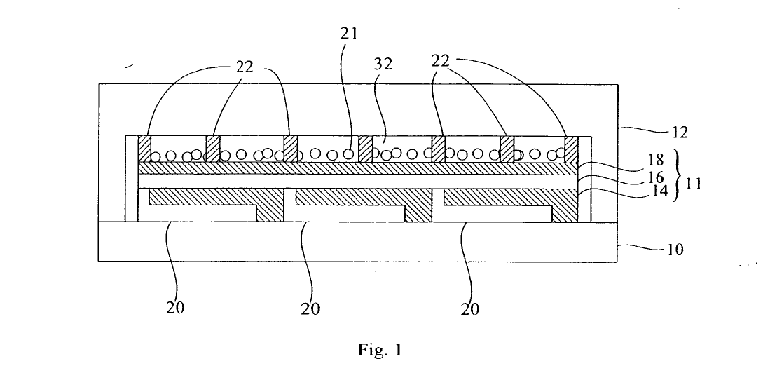

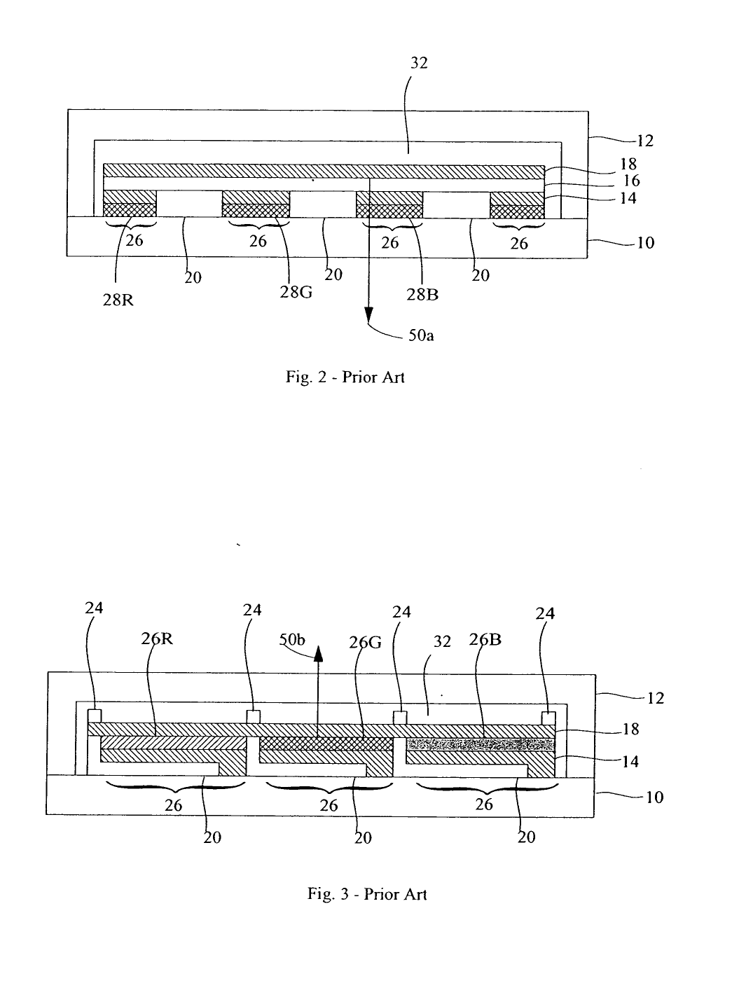

Referring to FIG. 1, in accordance with one embodiment of the present invention, an organic light-emitting diode (OLED) device is illustrated comprising a substrate 10; an OLED 11 formed on the substrate 10 comprising a first electrode 14 formed over the substrate 10, one or more layers of organic material 16, one of which emits light, formed over the first electrode 14, and a transparent second electrode 18 formed over the one or more layers of organic material 16, the transparent second electrode 18 and layer(s) of organic light-emitting material 16 having a first refractive index range; a transparent cover 12 provided over the OLED 11 through which light from the OLED 11 is emitted, the cover 12 having a second refractive index; a light scattering element 21 located between the substrate 10 and cover 12 for scattering light emitted by the light-emitting layer 16; and an auxiliary electrode grid 22 located above the transparent second electrode 18, providing spacing between the transparent second electrode 18 and the cover 12, and forming transparent gaps 32 between the transparent second electrode 18 and the cover 12 within grid openings, the transparent gaps having a third refractive index lower than each of the first refractive index range and second refractive index.

As employed herein, a light scattering layer is an optical layer that tends to randomly redirect any light that impinges on the layer from any direction. As used herein, a transparent electrode is one that passes some light and includes electrodes that are semi-transparent, partially reflective, or partially absorptive. Similarly as taught in co-pending, commonly assigned U.S. Ser. No. 11/065,082 filed Feb. 24, 2005 (docket 89211), the disclosure of which is hereby incorporated in its entirety by reference, the transparent electrode and layer(s) of organic light-emitting material have a first refractive index range, the transparent cover has a second refractive index, and a light scattering element is located between the substrate and cover. According to the present invention auxiliary electrode grid 22 located above the transparent second electrode 18 provides spacing between the transparent second electrode 18 and the cover 12, and forms transparent gaps 32 between the transparent second electrode 18 and the cover 12 within grid openings. As used herein, the term electrode grid refers to a network of relatively conductive material having relatively non-conductive grid openings between the conductive material. The transparent gaps 32 within the grid openings have a third refractive index lower than each of the first refractive index range and second refractive index.

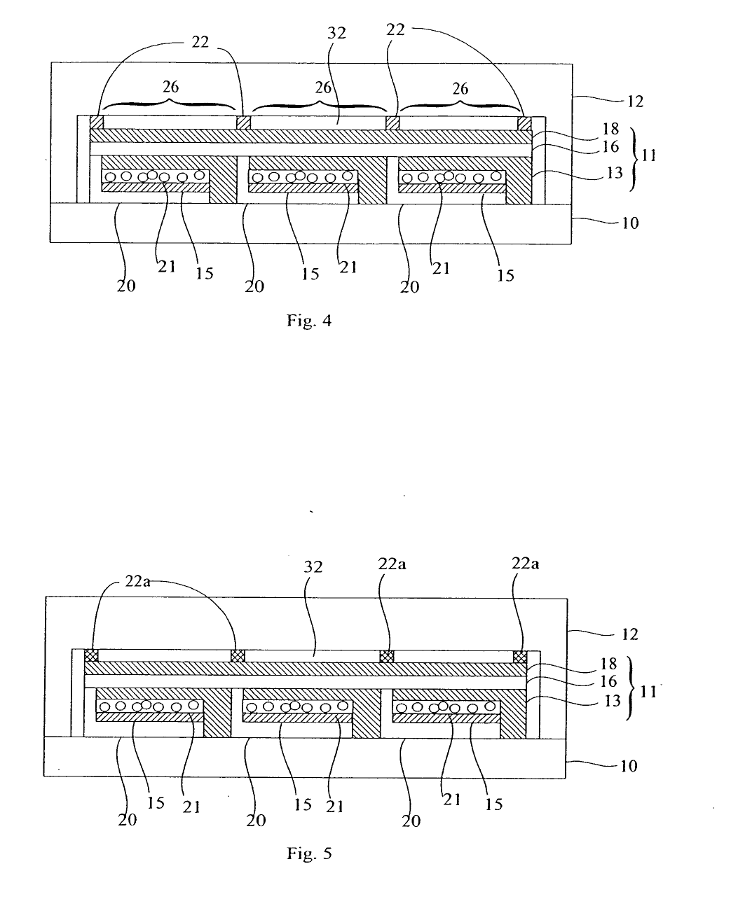

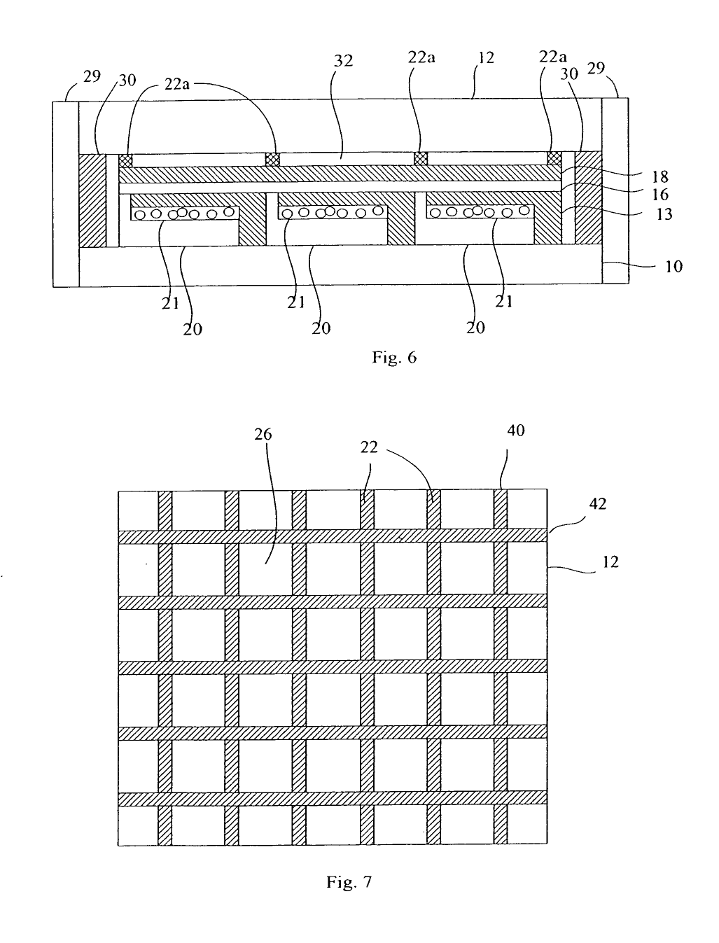

FIG. 1 illustrates placement of the light scattering element 21 between the transparent second electrode 18 and cover 12. Referring to FIG. 4, in an alternative embodiment, the first electrode 14 may comprise multiple layers, for example a transparent, electrically conductive layer 13 formed over a reflective layer 15. As shown in FIGS. 4 and 5, the scattering layer 21 may be located between the reflective layer 15 and the transparent, electrically conductive layer 13. The reflective layer 15 may also be conductive, as may the scattering layer 21. In this case, it is preferred that the transparent, conducting layer 13 have a refractive index in the first refractive index range. Referring to FIG. 6, in an alternative embodiment of the present invention, the scattering element 21 may also be reflective. In an alternative embodiment, the scattering element 21 itself may be an electrode (not shown).

In preferred embodiments, the encapsulating cover 12 and substrate 10 may comprise glass or plastic with typical refractive indices of between 1.4 and 1.6. The transparent gaps 32 within the auxiliary electrode grid 22 openings may comprise a solid layer of optically transparent material, a void, or a gap. Voids or gaps may be a vacuum or filled with an optically transparent gas or liquid material. For example air, nitrogen, helium, or argon all have a refractive index of between 1.0 and 1.1 and may be employed. Lower index solids which may be employed include fluorocarbon or MgF, each having indices less than 1.4. Any gas employed is preferably inert. Reflective first electrode 14 is preferably made of metal (for example aluminum, silver, or magnesium) or metal alloys. Transparent second electrode 18 is preferably made of transparent conductive materials, for example indium tin oxide (ITO) or other metal oxides. The organic material layers 16 may comprise organic materials known in the art, for example, hole-injection, hole-transport, light-emitting, electron-injection, and/or electron-transport layers. Such organic material layers are well known in the OLED art. The organic material layers typically have a refractive index of between 1.6 and 1.9, while indium tin oxide has a refractive index of approximately 1.8-2.1. Hence, the various layers 18 and 16 in the OLED have a refractive index range of 1.6 to 2.1. Of course, the refractive indices of various materials may be dependent on the wavelength of light passing through them, so the refractive index values cited here for these materials are only approximate. In any case, the transparent low-index gap preferably has a refractive index at least 0.1 lower than that of each of the first refractive index range and the second refractive index at the desired wavelength for the OLED emitter.

Scattering layer 21 may comprise a volume scattering layer or a surface scattering layer. In certain embodiments, e.g., scattering layer 21 may comprise materials having at least two different refractive indices. The scattering layer 21 may comprise, e.g., a matrix of lower refractive index and scattering elements have a higher refractive index. Alternatively, the matrix may have a higher refractive index and the scattering elements may have a lower refractive index. For example, the matrix may comprise silicon dioxide or cross-linked resin having indices of approximately 1.5, or silicon nitride with a much higher index of refraction. If scattering layer 21 has a thickness greater than one-tenth part of the wavelength of the emitted light, then it is desirable for the index of refraction of at least one material in the scattering layer 21 to be approximately equal to or greater than the first refractive index range. This is to insure that all of the light trapped in the organic layers 16 and transparent electrode 18 can experience the direction altering effects of scattering layer 21. If scattering layer 21 has a thickness less than one-tenth part of the wavelength of the emitted light, then the materials in the scattering layer need not have such a preference for their refractive indices.

In the alternative embodiments shown in FIGS. 1 and 4 or 5, scattering layer 22 may either comprise particles 23 deposited on another layer, e.g., particles of titanium dioxide may be coated over transparent electrode 18 to scatter light (FIG. 1) or formed in a layer within a matrix (FIGS. 4 and 5). Preferably, such particles are at least 100 nm in diameter to optimize the scattering of visible light. In a further top-emitter alternative (not shown), scattering layer 21 may comprise a rough, diffusely reflecting surface of electrode 14 itself.

The scattering layer 21 may be adjacent to and in contact with an electrode to defeat total internal reflection in the organic layers 16 and transparent electrode 18. However, if the scattering layer 21 is between the electrodes 14 and 18, it may not be necessary for the scattering layer to be in contact with an electrode 14 or 18 so long as it does not unduly disturb the generation of light in the OLED layers 16. According to an embodiment of the present invention, light emitted from the organic layers 16 can waveguide along the organic layers 16 and electrodes 18 combined, since the organic layers 16 have a refractive index lower than that of the transparent electrode 18 and electrode 14 is reflective. The scattering layer 21 or scattering surface disrupts the total internal reflection of light in the combined layers 16 and 18 and redirects some portion of the light out of the combined layers 16 and 18.

It is important to note that a scattering layer may also scatter light that would have been emitted out of the device back into the organic layers 16, exactly the opposite of the desired effect. Hence, the use of optically transparent layers that are as thin as possible is desired in order to extract light from the device with as few reflections as possible.

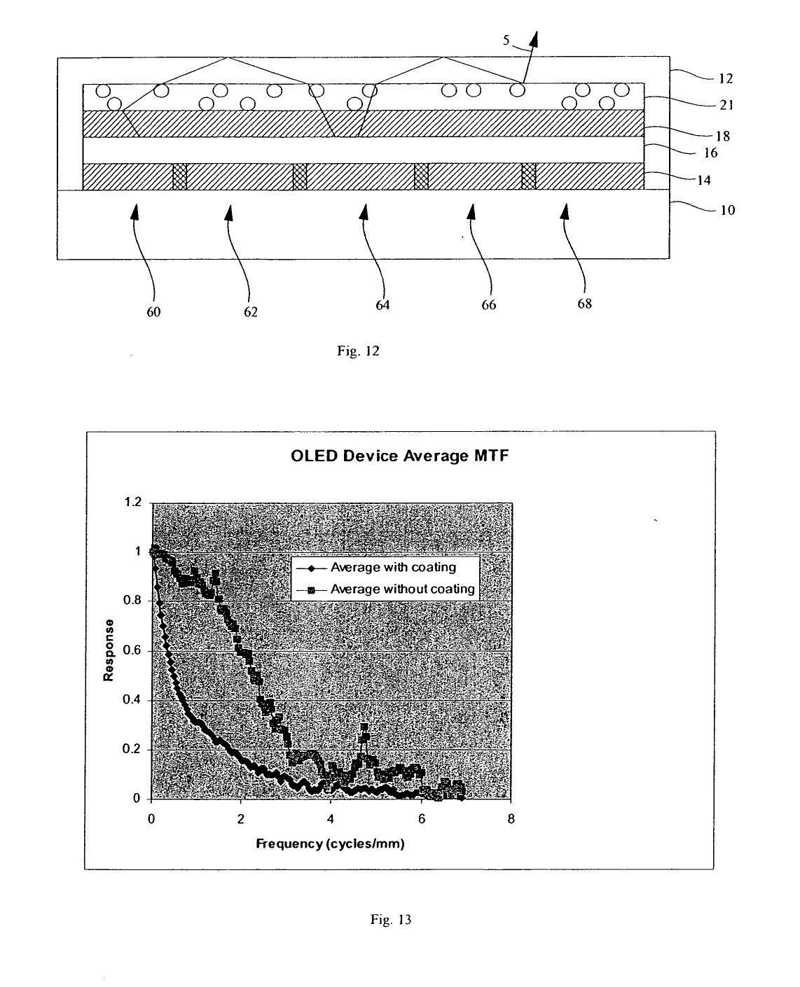

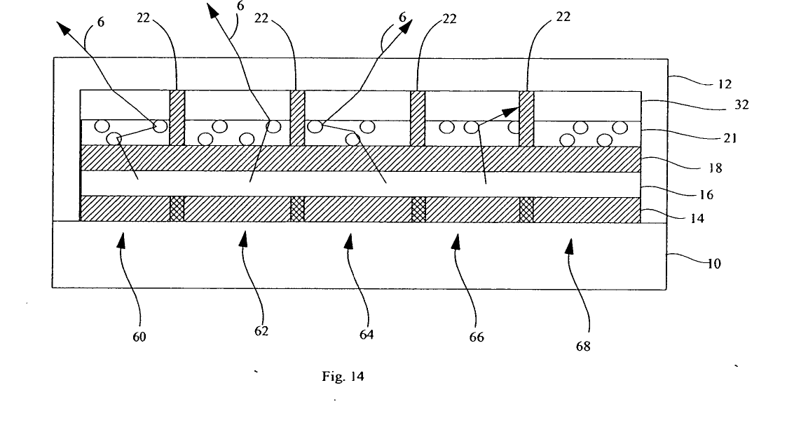

The present invention is preferred over the prior art because the number of interlayer reflections that the light encounters and the distance that scattered light travels in the encapsulating cover 12 are reduced. Referring to FIG. 14, after light rays 6 are scattered into an angle that allows it to escape from the organic layers 16 and transparent second electrode 18, it enters the transparent gaps 32 (for example, air) having a lower index of refraction than both the transparent electrode 18 and the encapsulating cover 12. Therefore, when the scattered light encounters the encapsulating cover 12, it will pass through the encapsulating cover 12 and be re-emitted on the other side, since light passing from a low-index medium into a higher-index medium cannot experience total internal reflection. Hence, the light will not experience the losses due to repeated transmission through the encapsulating cover 12 or demonstrate the lack of sharpness that results from light being emitted from the organic layers 16 at one point and emitted from the encapsulating cover 12 at a distant point, as illustrated in FIGS. 11 and 12. To facilitate this effect, the transparent relatively low-index gaps should not scatter light, and should be as transparent as possible. The transparent gaps preferably are at least one micron thick to ensure that emitted light properly propagates there through, and is transmitted through the encapsulating cover 12.

Whenever light crosses an interface between two layers of differing index (except for the case of total internal reflection), a portion of the light is reflected and another portion is refracted. Unwanted reflections can be reduced by the application of standard thin anti-reflection layers. Use of anti-reflection layers may be particularly useful on both sides of the encapsulating cover 12, for top emitters.

Use of a transparent low-index gap between the second electrode 18 and the cover 12 is useful for extracting additional light from the OLED device. However, in practice, when voids or gaps (filled with a gas or is a vacuum) are employed in a top-emitter configuration, the mechanical stability of the device may be affected, particularly for large devices. For example, if the OLED device is inadvertently curved or bent, or the encapsulating cover 12 or substrate 10 are deformed, the encapsulating cover 12 may come in contact with the transparent electrode 18 and destroy it. Hence, some means of preventing the encapsulating cover 12 from contacting the transparent electrode 18 in a top-emitter OLED device may be useful. According to the present invention, the auxiliary electrode grid 22 can be in contact with the encapsulating cover 12. By providing a mechanical contact between the encapsulating cover 12 and the auxiliary electrode grid 22 within or around the light-emitting area of the device, the OLED device can be made more rigid and a gap created. Alternatively, if flexible substrates 10 and covers 12 are employed, the auxiliary electrode grid 22 can prevent the encapsulating cover 12 from touching the OLED material layer(s) 16 and electrode 18. The auxiliary electrode grid 22 may be provided with reflective edges to assist with light emission for the light that is emitted toward the edges of each light-emitting area. Alternatively, auxiliary electrode grid 22 may be opaque or light absorbing. Preferably, the sides of the auxiliary electrode grid 22 are reflective while the tops may be black and light absorbing. A light-absorbing surface or coating will absorb ambient light incident on the OLED device, thereby improving the contrast of the device. Reflective coatings may be applied by evaporating thin metal layers. Light absorbing materials may employ, for example, color filters material known in the art. A useful height for the auxiliary electrode grid 22 above the surface of the OLED and any scattering element 21 is one micron or greater. An adhesive may be employed on the encapsulating cover 12 or auxiliary electrode grid 22 to affix the encapsulating cover 12 to the auxiliary electrode grid 22 to provide additional mechanical strength.

The scattering layer 21 can employ a variety of materials. For example, randomly located spheres of titanium dioxide may be employed in a matrix of polymeric material. Alternatively, a more structured arrangement employing ITO, silicon oxides, or silicon nitrides may be used. In a further embodiment, the refractive materials may be incorporated into the electrode itself so that the electrode is a scattering layer. Shapes of refractive elements may be cylindrical, rectangular, or spherical, but it is understood that the shape is not limited thereto. The difference in refractive indices between materials in the scattering layer 21 may be, for example, from 0.3 to 3, and a large difference is generally desired. The thickness of the scattering layer, or size of features in, or on the surface of, a scattering layer may be, for example, 0.03 to 50 μm. It is generally preferred to avoid diffractive effects in the scattering layer. Such effects may be avoided, for example, by locating features randomly or by ensuring that the sizes or distribution of the refractive elements are not the same as the wavelength of the color of light emitted by the device from the light-emitting area.

The scattering layer 21 should be selected to get the light out of the OLED as quickly as possible so as to reduce the opportunities for re-absorption by the various layers of the OLED device. If the scattering layer 21 is to be located between the organic layers 16 and the gap, or between the organic layers 16 and a reflective electrode 14, then the total diffuse transmittance of the same layer coated on a glass support should be high (preferably greater than 80%). In other embodiments, where the scattering layer 21 is itself desired to be reflective, then the total diffuse reflectance of the same layer coated on a glass support should be high (preferably greater than 80%). In all cases, the absorption of the scattering layer should be as low as possible (preferably less than 5%, and ideally 0%).

Materials of the light scattering layer 21 can include organic materials (for example polymers or electrically conductive polymers) or inorganic materials. The organic materials may include, e.g., one or more of polythiophene, PEDOT, PET, or PEN. The inorganic materials may include, e.g., one or more of SiOₓ (x>1), SiNₓ (x>1), Si₃N₄, TiO₂, MgO, ZnO, Al₂O₃, SnO₂, In₂O₃, MgF₂, and CaF₂. The scattering layer 21 may comprise, for example, silicon oxides and silicon nitrides having a refractive index of 1.6 to 1.8 and doped with titanium dioxide having a refractive index of 2.5 to 3. Polymeric materials having refractive indices in the range of 1.4 to 1.6 may be employed having a dispersion of refractive elements of material with a higher refractive index, for example titanium dioxide.

Conventional lithographic means can be used to create the scattering layer using, for example, photo-resist, mask exposures, and etching as known in the art. Alternatively, coating may be employed in which a liquid, for example a solvent or a polymer having a dispersion of titanium dioxide, may form a scattering layer 21.

In order to effectively space the OLED 11 from the cover 12 and provide a useful optical structure as discussed above, the auxiliary grid 22 preferably has a thickness of one micron or more but preferably less than one millimeter. When the scattering element 21 materials are coated above the second electrode layer, the auxiliary grid 22 must have an overall thickness greater than the scattering element 21 in order to provide a gap between the scattering element 21 and the encapsulating cover 12. Since the scattering element 21 preferably has a thickness greater than 500 nm and may be 1 to 2 microns in thickness, the auxiliary grid 22 preferably has an overall thickness of 1 micron or more. The auxiliary grid 22 may be 50 microns in thickness or more, but preferably maintains a thickness of less than 10 microns so as to maximize the sharpness of the device. Conventional lithographic means can be used to create the auxiliary electrode grid 22 using, for example, photo-resist, mask exposures, and etching as known in the art. Alternatively, coating may be employed in which a liquid, for example polymer having a dispersion of titanium dioxide, may form the auxiliary grid 22. The auxiliary grid 22 may be deposited using thick film or inkjet techniques. Heat transfer methods, for example employing lasers, may be employed. The auxiliary grid 22 may, or may not, employ masks to form the grid structure.

The auxiliary electrode grid 22 may comprise, for example, metals, metal oxides, electrically conductive polymers, carbon, or metal sulfides, and be coated with carbon, carbon black, pigmented inks, dyes, or barium oxide. Useful metals include aluminum, copper, magnesium, molybdenum, silver, titanium, or alloys thereof. Useful metal oxides include indium tin oxide or indium zinc oxide. The relatively conductive material network of the auxiliary grid 22 may be located anywhere over the OLED, but is preferably located between light-emitting portions of the OLED. By positioning the auxiliary electrode grid 22 between light-emitting portions 26 of the OLED, the auxiliary electrode grid 22 will not interfere with the light emitted from the OLED and may be employed to absorb ambient light, thereby improving the device contrast. If the auxiliary electrode grid 22 is located in light-emitting portions of the OLED, the auxiliary electrode grid 22 is preferably transparent to reduce any interference with the light emitted from the OLED.

The auxiliary electrode grid 22 may be applied to either the cover 12 or the OLED 11 before the cover 12 is located on the OLED 11 and after the OLED 11 is formed on the substrate 10. Once the cover 12 is formed and the OLED 11 with all of its layers deposited on the substrate, together with any electronic components, the auxiliary electrode grid 22 may be deposited on the OLED and the cover 12 brought into alignment with the OLED 11. Alternatively, the auxiliary electrode grid 22 may be distributed over the inside of the cover 12 and then the auxiliary electrode grid 22 and the cover 12 brought into alignment with the OLED 11 and substrate 10. Typically, the auxiliary electrode grid 22 is in contact with the cover 12 and the OLED 11 at the same time. Alternatively, the auxiliary electrode grid 22 may not be in contact with the cover 12 and the OLED 11 unless the substrate 10 or cover 12 is stressed, for example by bending.

Referring to FIG. 4, in one embodiment of the present invention, the auxiliary electrode grid 22 may be patterned over the surface of the OLED 11 or encapsulating cover 12. In this embodiment, the auxiliary electrode grid 22 may be located between the light-emitting areas 26 of the OLED device so that any light emitted by the OLED will not encounter the auxiliary grid 22 and thereby experience any undesired optical effect. Referring to FIG. 5, the auxiliary electrode grid 22a may be black and light absorbing, since no light is emitted from the areas in which the auxiliary electrode grid 22a is deposited and a black grid can then absorb stray emitted or ambient light, thereby increasing the sharpness and ambient contrast of the OLED device. The auxiliary electrode grid 22a may be located either around every light emitting area 26 or in areas between some of the light-emitting areas 26, for example in rows 42 or columns 40 between pixel groups as is shown in FIG. 7 or around the periphery of the light-emitting areas.

In a preferred embodiment, the auxiliary grid is located around the periphery of any light-emitting areas. In these locations, any pressure applied by the deformation of the encapsulating cover 12 or substrate 10 is transmitted to the auxiliary electrode grid 22 at the periphery of the light-emitting areas, thereby reducing the stress on the light-emitting materials. Although light-emitting materials may be coated over the entire OLED device, stressing or damaging them (without creating an electrical short) may not have a deleterious effect on the OLED device. If, for example, the top transparent electrode 18 is damaged, there may not be any change in light emission from the light-emitting areas 26. Moreover, the periphery of the OLED light-emitting areas may be taken up by more stress-resistant thin-film silicon materials.

The encapsulating cover 12 may or may not have a cavity forming the gaps 32. If the encapsulating cover does have a cavity, the cavity may be deep enough to contain the auxiliary electrode grid 22 so that the periphery of the encapsulating cover 12 may be affixed to the substrate, as shown in FIG. 1. The auxiliary electrode grid 22 may be in contact with only the inside of the encapsulating cover 12 (if applied to the cover) or be in contact with only the OLED 1 (if applied to the OLED), or to both the OLED 1 and the inside of the encapsulating cover 12. If the auxiliary electrode grid 22 is in contact with both the OLED 11 and the inside of the encapsulating cover 12 and the encapsulating cover 12 is affixed to the substrate 10, the cavity in the encapsulating cover 12 should have a depth approximately equal to the thickness of the auxiliary electrode grid 22. Alternatively, referring to FIG. 6, the encapsulating cover may not have a cavity. In this case, a sealant 30 should be employed to defeat the ingress of moisture into the OLED device. An additional end-cap 29 may be affixed to the edges of the encapsulating cover 12 and substrate 10 to further defeat the ingress of moisture or other environmental contaminants into the OLED device.

According to the present invention, an OLED device employing auxiliary electrode grid 22 located between an encapsulating cover 12 and an OLED 11 to form gaps 32, is more robust in the presence of stress applied to the cover 12 and/or the substrate 10. In a typical situation, the cover 12 is deformed either by bending the entire OLED device or by separately deforming the cover 12 or substrate 10, for example by pushing on the cover or substrate with a finger or hand or by striking the cover or substrate with an implement such as a ball. When this occurs, the substrate or cover will deform slightly putting pressure on the auxiliary grid, preventing the cover 12 or from pressing upon the OLED 11 and thereby maintaining the gap 32.

An additional protective layer may be applied to the electrode 18 in auxiliary electrode grid 22 openings, or applied to both the electrode 18 and the auxiliary electrode grid 22 itself, to provide environmental and mechanical protection, or to provide useful optical effects. For example, parylene or a plurality of layers of Al₂O₃ may be coated over the electrode 18 to provide a hermetic seal and may also provide useful optical properties to the electrode 18.

It is not essential that all of the relatively conductive material grid elements of the auxiliary electrode grid 22 have the same shape or size. In some embodiments of the present invention, the relatively conductive material grid elements of the auxiliary electrode grid 22 may have rectangular cross sections.

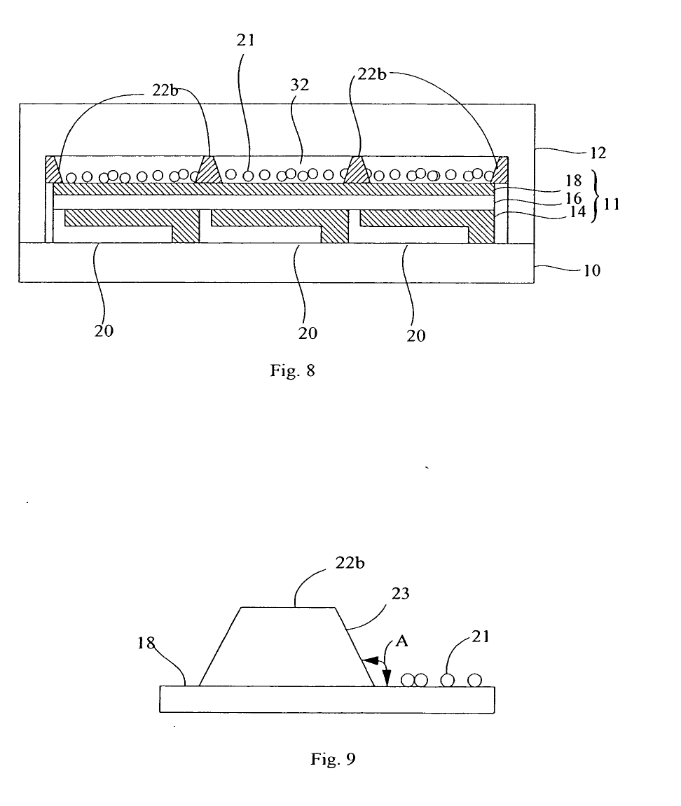

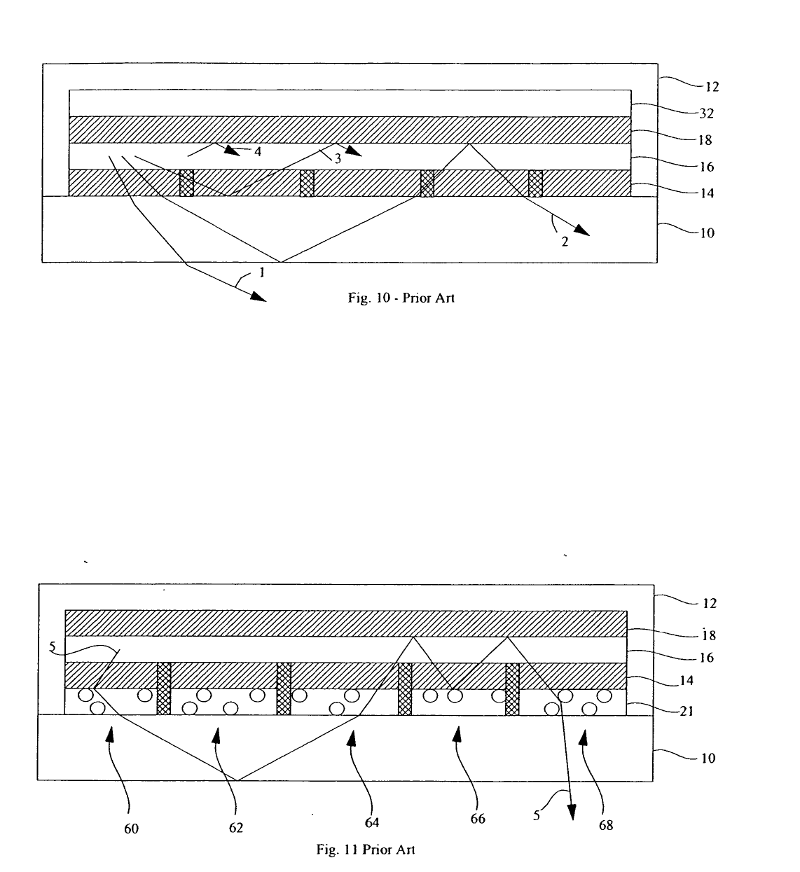

Alternatively, as shown in FIGS. 8 and 9, auxiliary electrode grid 22 may comprise grid elements 22b having sides 23 extending from the surface of the transparent second electrode 18, and wherein at least a portion of the sides are light reflective and/or form an angle A of greater than 90 degrees relative to the surface of the second electrode within the grid openings. For example, as shown in FIG. 9, the auxiliary electrode grid 22 may have a trapezoidal cross section. In a preferred embodiment of the present invention, at least a portion of the sides 23 of the auxiliary electrode grid are reflective, to enhance light reflected or refracted from the scattering element 21.

In order to maintain a robust and tight seal around the periphery of the substrate and cover, and to avoid possible motion of the cover 12 with respect to the substrate 10 and possibly damaging the electrodes and organic materials of the OLED, it is possible to adhere the cover to the substrate in an environment that has a pressure of less than one atmosphere. If the gap is filled with a relatively lower-pressure gas (for example air, nitrogen, or argon), this will provide pressure between the cover and substrate to help prevent motion between the cover and substrate, thereby creating a more robust component.

Most OLED devices are sensitive to moisture or oxygen, or both, so they are commonly sealed in an inert atmosphere such as nitrogen or argon, along with a moisture-absorbing desiccant such as alumina, bauxite, calcium sulfate, clays, silica gel, zeolites, barium oxide, alkaline metal oxides, alkaline earth metal oxides, sulfates, or metal halides and perchlorates. The auxiliary electrode grid 22 may have desiccating properties and may include one or more of the desiccant materials.

OLED devices of this invention can employ various well-known optical effects in order to enhance their properties if desired. This includes optimizing layer thicknesses to yield maximum light transmission, providing dielectric mirror structures, replacing reflective electrodes with light-absorbing electrodes, providing anti-glare or anti-reflection coatings over the display, providing a polarizing medium over the display, or providing colored, neutral density, or color conversion filters over the display. Filters, polarizers, and anti-glare or anti-reflection coatings may be specifically provided over the cover or as part of the cover.

The present invention may also be practiced with either active- or passive-matrix OLED devices. It may also be employed in display devices or in area illumination devices. In a preferred embodiment, the present invention is employed in a flat-panel OLED device composed of small molecule or polymeric OLEDs as disclosed in but not limited to U.S. Pat. No. 4,769,292, issued Sep. 6, 1988 to Tang et al., and U.S. Pat. No. 5,061,569, issued Oct. 29, 1991 to VanSlyke et al. Many combinations and variations of organic light-emitting displays can be used to fabricate such a device, including both active- and passive-matrix OLED displays having either a top- or bottom-emitter architecture.

The invention has been described in detail with particular reference to certain preferred embodiments thereof, but it will be understood that variations and modifications can be effected within the spirit and scope of the invention.

### PARTS LIST

1, 2, 3, 4, 5, 6 light rays
10 substrate
11 OLED
12 encapsulating cover
13 transparent electrode
14 electrode
15 reflector
16 organic layers
18 electrode
20 thin-film electronic components
21 light scattering element
22, 22a, 22b auxiliary electrode grid
23 side
24 auxiliary electrode
26 light-emitting area
26R, 26G, 26B red, green, and blue light-emitting areas
28R, 28G, 28B red, green, and blue color filters
29 end cap
30 sealant
32 gap
40 columns between light-emitting areas
42 rows between light-emitting areas
50a, 50b light
60, 62, 64, 66, 68 pixels
A angle

1. An organic light-emitting diode (OLED) device, comprising:
a substrate;
an OLED formed on the substrate comprising a first electrode formed over the substrate, one or more layers of organic material, one of which emits light, formed over the first electrode, and a transparent second electrode formed over the one or more layers of organic material, the transparent second electrode and layer(s) of organic light-emitting material having a first refractive index range;
a transparent cover provided over the OLED through which light from the OLED is emitted, the cover having a second refractive index;
a light scattering layer located between the substrate and cover for scattering light emitted by the light-emitting layer; and
an auxiliary electrode grid located above the transparent second electrode, providing spacing between the transparent second electrode and the cover, and forming transparent gaps between the transparent second electrode and the cover within grid openings, the transparent gaps having a third refractive index lower than each of the first refractive index range and second refractive index.

2. The OLED device of claim 1, wherein the auxiliary electrode grid is black or forms a black matrix.

3. The OLED device of claim 1, further comprising one or more protective and/or optical layers formed over the transparent second electrode and/or electrode grid.

4. The OLED device of claim 1, wherein the auxiliary electrode grid is randomly located over the transparent second electrode, is regularly distributed over the transparent second electrode, or is located between light-emitting portions of the OLED device.

5. The OLED device of claim 1, wherein the auxiliary electrode grid is transparent or light absorbing.

6. The OLED device of claim 1, wherein the auxiliary electrode grid comprises a conductive polymer, metal, metal oxide, carbon, or metal sulfide.

7. The OLED display claimed in claim 6, wherein the auxiliary electrode grid comprises aluminum, copper, magnesium, molybdenum, silver, titanium, or alloys thereof.

8. The OLED display claimed in claim 6, wherein the auxiliary electrode grid comprises indium tin oxide or indium zinc oxide.

9. The OLED device of claim 1, wherein the cover is affixed directly to the substrate.

10. The OLED device of claim 1, further comprising an encapsulating end-cap affixed to both the cover and the substrate.

11. The OLED device of claim 10, wherein the transparent gaps are filled with an inert gas, air, nitrogen, or argon.

12. The OLED device of claim 1, wherein the auxiliary electrode grid has a thickness equal to or greater than 1 micron.

13. The OLED device of claim 1, wherein the auxiliary electrode grid is in contact with the cover and the transparent second electrode.

14. The OLED device of claim 1, wherein the transparent gaps are maintained at a pressure of less than one atmosphere.

15. The OLED device of claim 1, wherein the scattering layer is adjacent to and in contact with the transparent second electrode.

16. The OLED device of claim 15, wherein scattering layer located in the transparent gaps between the transparent second electrode and the cover within grid openings.

17. The OLED device of claim 16, wherein the scattering layer comprises scattering particles having a size less than the thickness of the auxiliary electrode grid.

18. The OLED device of claim 1, wherein the light scattering layer is an electrode.

19. The OLED device of claim 1, wherein the auxiliary electrode grid comprises grid elements having sides extending from the surface of the transparent second electrode, and wherein at least a portion of the sides are light reflective and/or form an angle of greater than 90 degrees relative to the surface of the second electrode within the grid openings.
